(19) United States
(12) Patent Application Publication
(10) Pub. No.: US 2007/0219034 A1
(43) Pub. Date: Sep. 20, 2007

(54) Detachable link plate

(76) Inventor: Hua-Tien Wu, Render Hsiang (TW)

Correspondence Address: COOPER & DUNHAM, LLP, 1185 AVENUE OF THE AMERICAS, NEW YORK, NY, 10036, US

(21) Appl. No.: 11/378,968

(22) Filed: Mar. 17, 2006

(51) Int. Cl. F16G 13/02

(52) U.S. Cl. 474/230

(57) ABSTRACT

A detachable link plate for a chain has two end sections, a middle section formed between the two end sections, two locking holes defined respectively through the two end sections, at least one through hole defined through the middle section and at least one fastening portion. Each of the at least one through holes is adjacent to at least one of the locking holes in the detachable link plate. The at least one fastening portion is formed between at least one of the locking holes and an adjacent through hole. Bending the at least one fastening portion into a corresponding neck of a detachable link pin ensures that the detachable link pins will not detach from the detachable link plate and cause the chain to separate.

### BACKGROUND OF THE INVENTION

1.Field of the Invention

The present invention relates to a detachable link, and more particularly to a detachable link plate.

2. Description of the Related Art

To connect and rotate two sprockets, a chain having two ends is looped around the sprockets, and the ends are connected with a detachable link.

With reference to FIG. 12, a chain has two ends, multiple inner links, multiple outer links, multiple chain pins (50) and a detachable link assembly.

The inner links are mounted pivotally in line in the chain and at ends of the chain to form connector links, and each inner link has two inner plates (20). The inner plates (20) are elongated and are mounted beside each other, and each inner plate (20) has two ends and two inner pivot holes (21). The inner pivot holes are defined through each inner plate (20) respectively near the ends of the inner plate (20) and align respectively with the inner pivot holes (21) in the adjacent inner plate (20).

The outer links are pivotally connected respectively to adjacent inner links, and each outer link has two outer plates (60). The outer plates (60) are elongated and are mounted parallel to each other respectively outside the inner plates (20) on adjacent inner links, and each outer plate (60) has two ends and two outer pivot holes (61). The outer pivot holes (61) are defined through each outer plate (60) respectively near the ends of the outer plate (60) align respectively with the outer pivot holes (61) in the parallel outer plate (60) and the pivot holes (21) in the adjacent inner plates (20).

The chain pins (50) pivotally connect adjacent inner and outer links and are mounted respectively through the aligned outer and inner pivot holes (61, 21), and each chain pin (50) has a shaft and two flanges. The shaft is mounted through the outer pivot holes (61) and rotatably in the inner pivot holes (21) and has two ends. The flanges are formed respectively on and protrude radially out from the ends of the shaft, are securely mounted respectively in the outer pivot holes (61) and are larger than the outer pivot holes (61).

The detachable link assembly pivotally connects the connector links and has an outer plate (60), a detachable link plate (40) and two detachable link pins (30).

The outer plate (60) is mounted against adjacent ends of the connector links, is the same as the outer plates (60) in an outer link. Since description of the outer plate (60) would be redundant, the description has been omitted. The outer pivot holes (61) align respectively with the inner pivot holes (21) in the adjacent connector links.

With further reference to FIG. 11, the detachable link plate (40) has two ends sections, a middle section and two locking holes (41). The two locking holes (41) are defined through the detachable link plate (40) respectively near the two ends. The locking holes (41) align with the two outer pivot holes (61) in the outer plate (60) of the detachable link assembly and are eccentric, and each locking holes (41) has a major hole (41 1) and a minor hole (412). The major hole (411) has a diameter and is formed near the middle of the detachable link plate (40). The minor hole (412) is formed near the end of the detachable link plate (40), communicates with the major hole (411) and has a diameter. The diameter of the minor hole (411) is smaller than the diameter of the major hole (412).

The two detachable link pins (30) are securely mounted respectively in the outer pivot holes (61) in the outer plate (60) of the detachable link assembly, are rotatably mounted in the inner pivot holes (21) respectively of the inner plates (20) of the connector links and are mounted respectively in the locking holes (41) in the detachable link plate (40). Each detachable link pin (30) has a shaft, a flange (31) and a neck (33).

The shaft is mounted rotatably in the inner pivot holes (21) in the inner plates (20) respectively of the connector link, and each shaft has a proximal end, a distal end and a diameter. The diameter is slightly smaller than the diameter of the major hole (411) and slightly larger than the diameter of the minor hole (412).

The flange (31) is formed on and protrudes radially from the proximal end of the shaft and has a diameter, and the flanges are mounted respectively in the outer pivot holes (61) in the outer plate (60). The diameter is bigger than the outer pivot hole (61) in the outer plate (60).

With further reference to FIG. 13, the neck (33) is formed around the shaft near the distal end, is mounted securely in minor hole (412) of the locking hole (41) in the detachable link plate (40) and has a diameter. The diameter of the neck (33) corresponds to the diameter of minor hole (411) so the neck can be held securely in the minor hole (412) when the chain is taut. However, when the chain is not taut, the neck (33) of the detachable link pin (30) easily slides out of the minor hole (412) and detaches from the connector link of the chain.

### SUMMARY OF THE INVENTION

The primary objective of the present invention is to provide a detachable link plate for a chain to join two ends of the chain and prevent the two ends from detaching from each other when the chain is not taut.

The detachable link plate in accordance with the present invention is mounted on detachable link pins mounted through connector links of the chain and has two end sections, a middle section, two locking holes, at least one through hole and at least one fastening portion. The middle section is formed between the two end sections. The two locking holes are defined through the detachable link plate respectively in the two ends sections and are detachably mounted respectively on necks of detachable link pins. The at least one through hole is defined through the middle section adjacent to at least one of the locking holes. The at least one fastening portion is formed between at least one of the locking hole and an adjacent through hole. Bending the at least one fastening portion into a corresponding neck of a detachable link pin ensures that the detachable link pin will not detach inadvertently from the detachable link plate. Thus, the detachable link pins cannot inadvertently detach from the locking holes, and ends of the chain are joined by the detachable link plate whether the chain is taut or not.

Other objectives, advantages and novel features of the invention will become more apparent from the following detailed description when taken in conjunction link with the accompanying drawings.

### BRIEF DESCRIPTION OF THE DRAWINGS

FIG. 1 is a perspective view of a first embodiment of a detachable link plate in accordance with the present invention;

FIG. 2 is a perspective view of a second embodiment of the detachable link plate in accordance with the present invention;

FIG. 3 is a perspective view of a third embodiment of the detachable link plate in accordance with the present invention;

FIG. 4 is an operational side view of the detachable link plate in FIG. 1 before a fastening portion of the detachable link plate is pressed into a neck of a detachable link pin;

FIG. 5 is an operational side view of the detachable link plate in FIG. 1 with the fastening portion of the detachable link plate deformed into the neck of the detachable link pin;

FIG. 6 is a top view in partial section of the detachable link plate in FIG. 1 attaching ends of a chain;

FIG. 7 is a perspective view of a forth embodiment of the detachable link plate in accordance with the present invention;

FIG. 8 is an operational side view of the detachable link plate in FIG. 7 before a fastening portion of the detachable link plate is pressed into a neck of a detachable link pin;

FIG. 9 is an operational side view of the detachable link plate in FIG. 7 with the fastening portion of the detachable link plate deformed into the neck of the detachable link pin;

FIG. 10 is a top view in partial section of the detachable link plate in FIG. 7 attaching ends of a chain;

FIG. 11 is a side view of a conventional detachable link plate in accordance with the prior art;

FIG. 12 is a top view in partial section of the conventional detachable link plate in FIG. 7 attaching ends of a chain; and

FIG. 13 is an operational side view of the conventional detachable link plate in FIG. 11 mounted on two detachable link pins of the conventional detachable link plate.

### DETAILED DESCRIPTION OF THE PREFERRED EMBODIMENT

With reference to FIG. 6, a chain has two ends, multiple inner links, outer links and multiple pins (50). The inner links are formed by multiple pairs of inner plates (20), and two pairs of inner links respectively at ends of the chain are connector links. Each inner plate (20) has two ends and two inner pivot holes (21). The inner pivot holes (21) are formed respectively near the ends of the inner plate (20), and the inner pivot holes (21) in one inner plate (20) in each pair of inner plates (20) align with the inner pivot holes (21) in the other inner plate (20). The outer links are mounted pivotally between adjacent inner links, and each outer link has a pair of outer plates (60). Each pin (50) pivotally connects adjacent inner and outer links. A pair of detachable link plates (10) in accordance with the present invention and two detachable link pins (30) form a detachable link that connects the connector links respectively at the ends of the chain to form a loop.

The detachable link pins (30) have a shaft, a flange (31) and a neck (33) and are conventional so further description has been omitted to reduce redundancy.

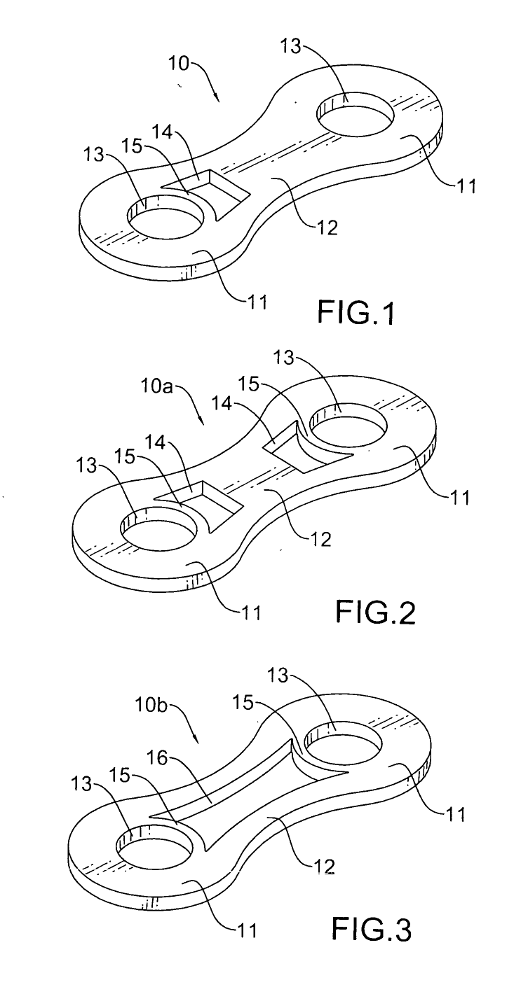

With further reference to FIGS. 1-3 and 7, each detachable link plate (10, 10a, 10b, 10c) is elongated and flat and has two end sections (11), a middle section (12), two locking holes (13, 13c), two optional annular lips (17), at least one through hole (14, 16) and at least one fastening portion (15, 15c).

The middle section (12) is formed between the two end sections (11).

The two locking holes (13, 13c) are formed respectively through the two end sections (11), are aligned respectively with the inner pivot holes (21) in the inner plates (20) of the connector links and each have an inner periphery, such that the detachable link pins (30) can be mounted respectively in the aligned locking holes (13, 13c) and pivot holes (21).

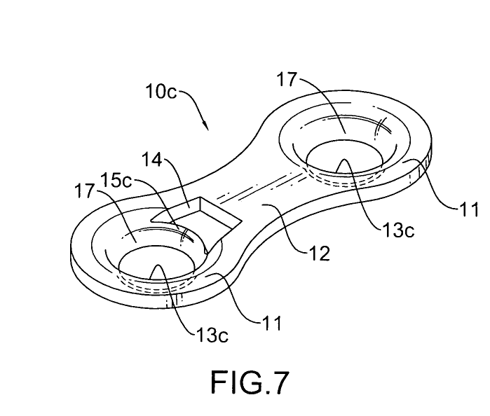

With further reference to FIG. 7, the two annular lips (17) are formed respectively on the inside peripheries of the locking holes (13c), protrude from one side of the detachable link plate (10c) and are mounted respectively in the inner pivot holes (21) in the inner plates (20) of the connector links.

The at least one through hole (14, 16) is formed through the middle section (12) adjacent to at least one of the locking holes (13, 13c), may be one or two through holes (14) adjacent respectively to one or two locking holes (13) and may be one through hole (16) elongated and adjacent to both locking holes (13).

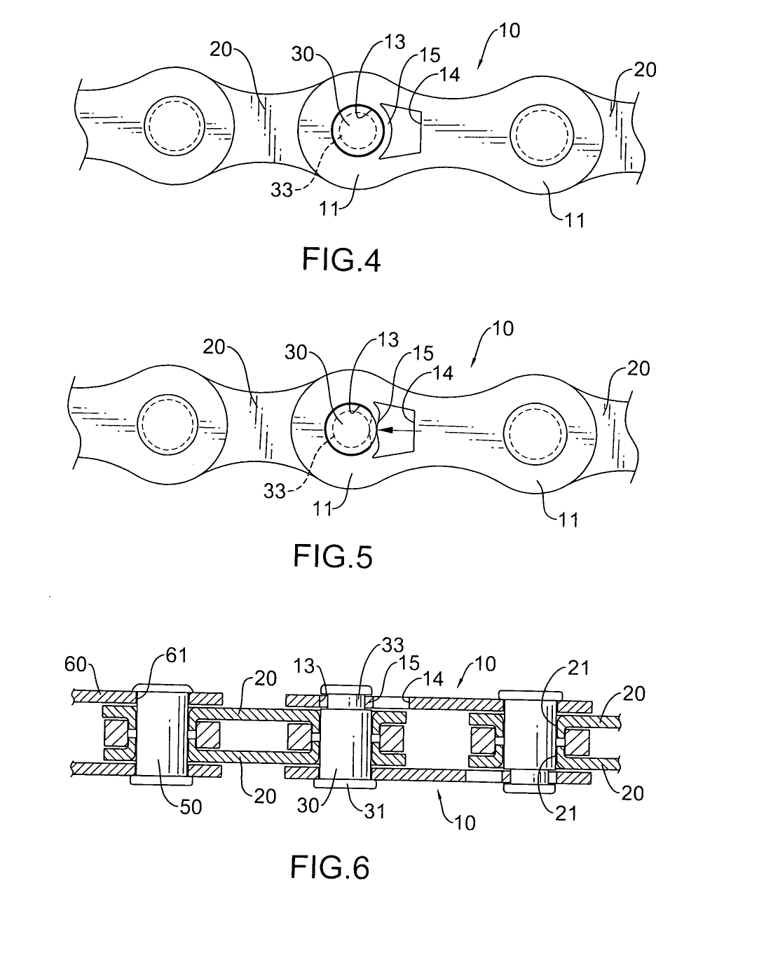

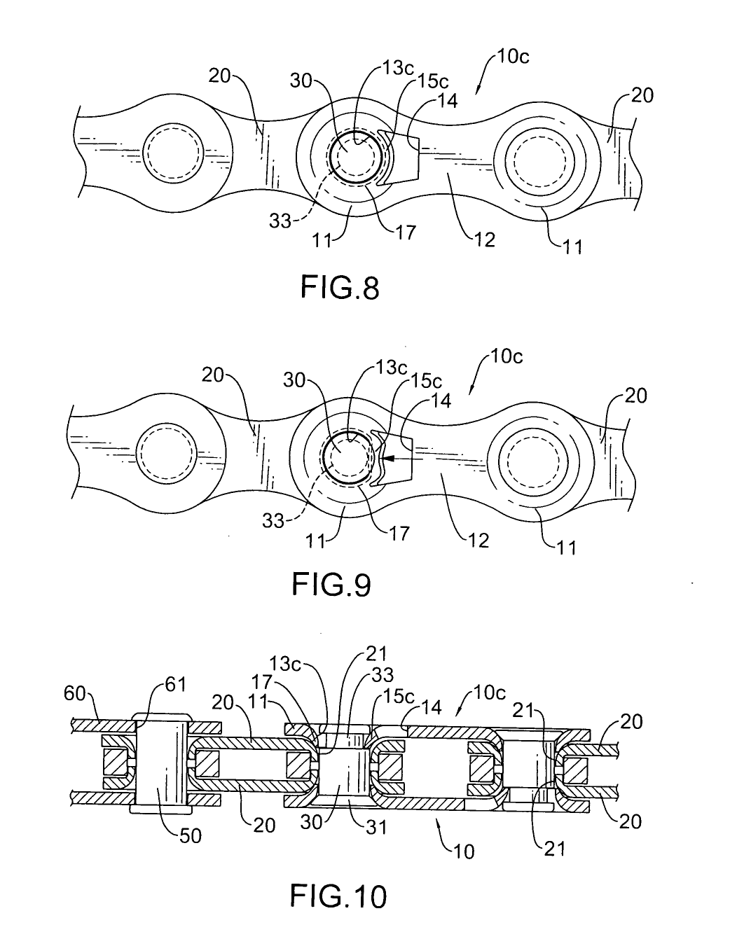

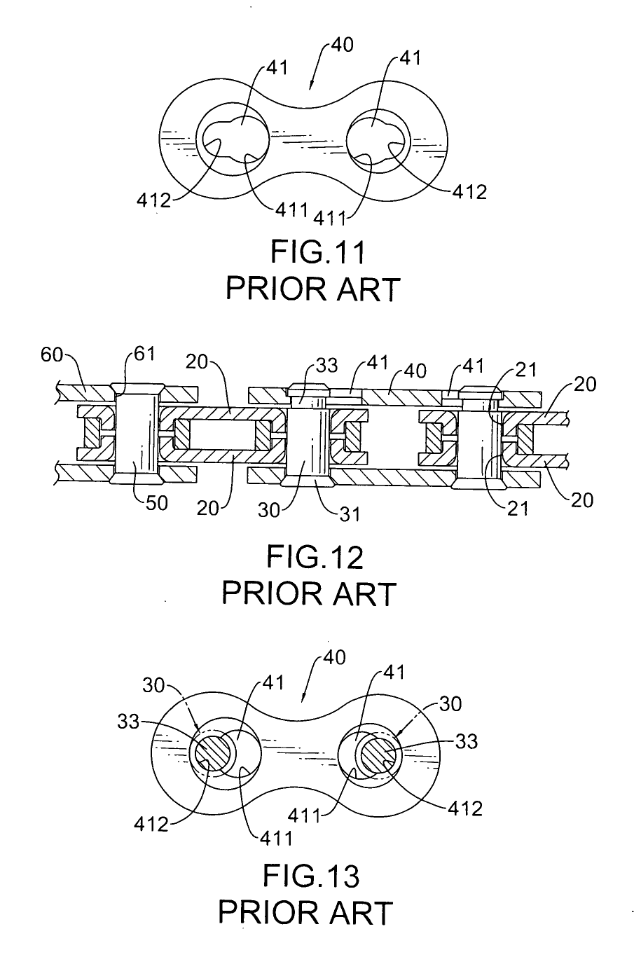

With further reference to FIGS. 4 to 6 and 8 to 10, the at least one fastening portion (15, 15c) is formed between at least one of the locking holes (13, 13c) and an adjacent through hole (14, 16), aligns with a neck (33) of a detachable link pin (30) mounted in the pivot holes (21) and the locking holes (13, 13c), may be curved or straight and is bent into the neck (33) to hold the detachable link together and securely connect the connector links.

The detachable link plate (10, 10a, 10b, 10c) as described keeps the detachable link pins (30) from detaching from the detachable link plate (10, 10a, 10b, 10c) whether the chain is taut or not.

Even though numerous characteristics and advantages of the present invention have been set forth in the foregoing description, together with details of the structure and features of the invention, the disclosure is illustrative only. Changes may be made in the details, especially in matters of shape, size and arrangement of parts within the principles of the invention to the full extent indicated by the broad general meaning of the terms in which the appended claims are expressed.

What is claimed is:

1. A detachable link plate for a chain comprising:
two end sections;
a middle section formed between the two end sections;
two locking holes formed respectively through the two end sections and each having an inner periphery; and
at least one through hole formed through the middle section and adjacent to at least one of the locking holes in the detachable link plate;
at least one fastening portion formed between at least one of the locking holes and an adjacent through hole.

2. The detachable link plate as claimed in claim 1, wherein the at least one through hole is one through hole formed through the middle section and adjacent to one of the locking holes.

3. The detachable link plate as claimed in claim 1, wherein the at least one through hole is two through holes formed through the middle section and adjacent respectively to the two locking holes.

4. The detachable link plate as claimed in claim 1, wherein the at least one through hole is one through hole formed though the middle section, elongated and adjacent to both locking holes.

5. The detachable link plate as claimed in claim 1, wherein the at least one fastening portion is curved.

6. The detachable link plate as claimed in claim 2, wherein the fastening portion is curved.

7. The detachable link plate as claimed in claim 3, wherein the two fastening portions are curved.

8. The detachable link plate as claimed in claim 4, wherein the two fastening portions are curved.

9. The detachable link plate as claimed in claim 1, wherein the detachable link plate further has two annular lips formed respectively on the inner peripheries of the two locking holes and protruding from one side of the detachable link plate.
